(19) United States
(12) Patent Application Publication
(10) Pub. No.: US 2019/0144139 A1
(43) Pub. Date: May 16, 2019

(54) LARGE APERTURE UNFURLABLE REFLECTOR DEPLOYED BY A TELESCOPIC BOOM

(71) Applicant: NORTHROP GRUMMAN SYSTEMS CORPORATION, FALLS CHURCH, VA (US)

(72) Inventor: GEOFFREY W. MARKS, SANTA BARBARA, CA (US)

(21) Appl. No.: 15/811,345

(22) Filed: Nov. 13, 2017

(51) Int. Cl. B64G 1/22

(52) U.S. Cl. CPC B64G 1/222

(57) ABSTRACT

A boom and reflector assembly for a spacecraft including a telescopic boom having a plurality of tubular sections that are nested together within a base section when the boom is in a stowed position, where the base section is mounted to a stowing cradle within the spacecraft by a root hinge. The assembly also includes a reflector having an outer truss structure including truss rods that are collapsible to allow the reflector to be collapsed into a stowed configuration, where the reflector is mounted to an outer one of the tubular sections having a smallest diameter by a wrist hinge. The assembly is configured to be released by the root hinge to rotate the boom and the reflector, rotate the collapsed reflector on the wrist hinge, deploy the reflector from the collapsed configuration to a deployed configuration, and then extend the boom to move the reflector away from the spacecraft.

### BACKGROUND

### Field

This invention relates to a telescopic boom and reflector assembly deployable from a spacecraft and, more particularly, to a telescopic boom and reflector assembly deployable from a spacecraft, where the assembly is configured so that the boom is deployed from the spacecraft and the reflector can be unfurled prior to the boom being extended in a telescoping manner.

### Discussion

Spacecraft typically employ various types of devices, such as reflectors, antenna arrays, sensors, etc., that must be deployed from the spacecraft on a boom when the spacecraft is on orbit or in space. Known booms for this purpose typically employ support rods coupled together by hinges that allow the boom to be folded or stowed in the spacecraft envelope or fairing during launch, and then be unfolded in space to the deployed position. Various devices and techniques are known in the art for unfolding or deploying a boom, including the use of motors, preloaded springs and various types of actuators.

For certain types of spacecraft, such as communication satellites in geostationary orbit, large reflectors are often employed to collect receive signals, such as a satellite uplink signals, and direct those signals to a transceiver on the spacecraft, and direct transmit signals from the transceiver on the spacecraft towards a receiver, such as a satellite downlink signal. These types of reflectors are collapsed into a stowed configuration during satellite launch, and then unfurled on a suitable truss structure and extended by a boom once the spacecraft is in position on orbit. The known booms for extending such reflectors from the spacecraft are typically foldable booms having hinged sections that are stowed on the satellite during launch, and then unfolded or deployed when the satellite is on orbit using spring-loaded actuators. The performance of various types of communications and other satellites can often be improved by increasing the size of the reflector, which requires longer booms to extend the reflector farther from the spacecraft. However, the size of the available spacecraft stowage space typically acts to limit the size of the reflector and deployment booms, primarily the length and stiffness of the booms for those types of booms having hinged sections.

### BRIEF DESCRIPTION OF THE DRAWINGS

FIG. 1 is an isometric view of a spacecraft structure including a stowed telescopic boom and reflector assembly;

FIG. 2 is an isometric view of the spacecraft structure showing the telescopic boom and reflector assembly being partially deployed;

FIG. 3 is an isometric view of the spacecraft structure showing the telescopic boom and reflector assembly being further partially deployed; and

FIG. 4 is an isometric view of the spacecraft showing the telescopic boom and reflector assembly being fully deployed.

### DETAILED DESCRIPTION OF THE EMBODIMENTS

The following discussion of the embodiments of the invention directed to a telescopic boom and reflector assembly is merely exemplary in nature, and is in no way intended to limit the invention or its applications or uses.

FIG. 1 is an isometric view of a spacecraft structure 10 that is provided within a spacecraft body of a spacecraft, such as a communications or radar satellite. The structure 10 includes side walls 12 and 14 defining a stowing cradle 16 to which is mounted a boom and reflector assembly 20 including a telescopic boom 22 and a reflector 24, where the assembly 20 is shown in its fully stowed configuration. As will be discussed in detail below, the boom 22 includes a number of tubular sections having gradually decreasing diameters that are nested inside of each other and deployable in a telescoping manner. The boom 22 includes a base tubular section 26 having the largest diameter of the sections that is mounted to the stowing cradle 16 at one end by a root hinge 28. The reflector 24 includes an outer truss structure 30 that is collapsed into a stowed configuration and held in that configuration by a strap 32, and is mounted to an opposite end of the boom 22 from the root hinge 28, specifically to the smallest diameter tubular section, by a support member 34 and a wrist hinge 36. The tubular sections of the boom 22 are made of a suitable material, such as graphite, and have a suitable stiffness so that they are able to support the reflector 24 in a deployed position some distance from the spacecraft body. The boom 22 can have any number of sections for a particular application. In one non-limiting embodiment, the boom 22 includes ten sections each being approximately ten feet long to provide a 100 foot boom. However, it is noted that the size of the assembly 20 is limited by the space available on the spacecraft.

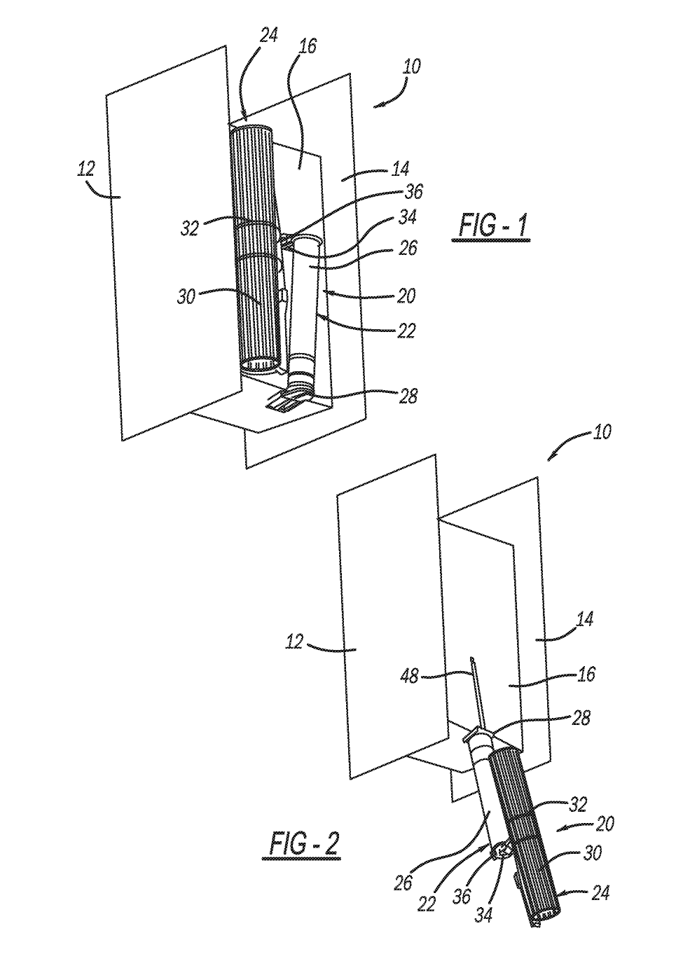

FIG. 2 is an isometric view of the spacecraft structure 10 showing the assembly 20 being in a partially deployed configuration. Particularly, the assembly 20 is released from the stowing cradle 16 by, for example, a pyro-release mechanism (not shown), and the assembly 20 is rotated out of the cradle 16 by the root hinge 28. It is noted that employing the hinge 28 for rotating the assembly 20 out of the cradle 16 is one way of releasing the assembly 20, where other techniques may be employed. For example, the boom 22 could be attached to the cradle 16 so that it extends straight out without any rotation, where the root hinge would be eliminated. After the root hinge 28 is fully opened and locked in place, the wrist hinge 36 is actuated to rotate the collapsed reflector 24 from the fully stowed position shown in FIG. 1 to the partially deployed position shown in FIG. 2.

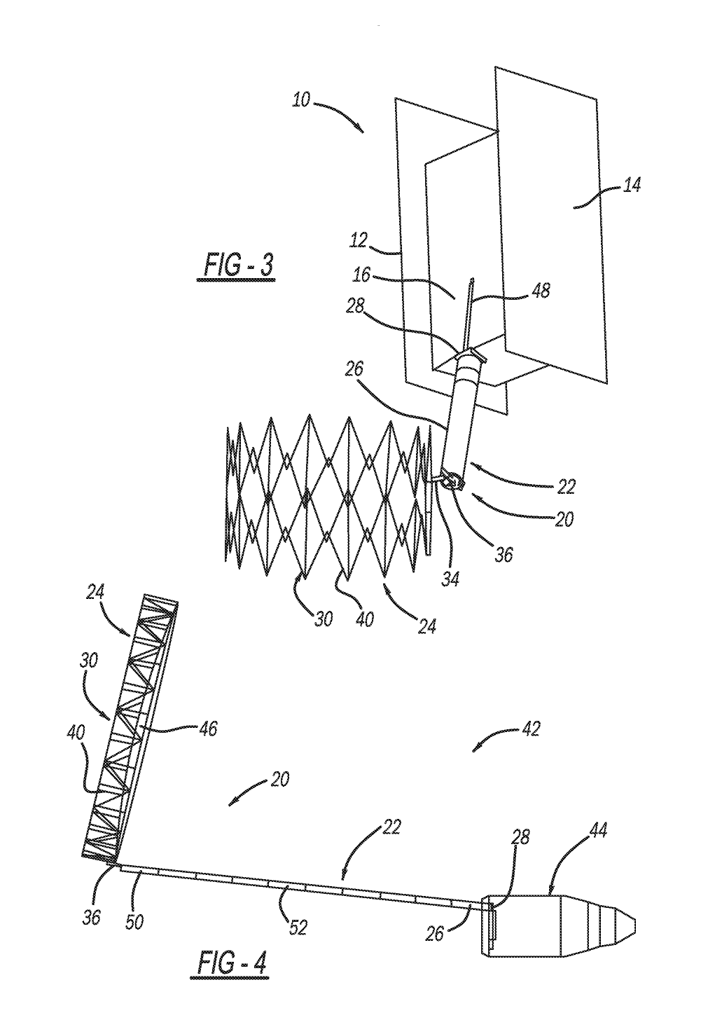

FIG. 3 is an isometric view of the spacecraft structure 10 showing the boom 22 still in its released but undeployed position, and the reflector 24 in a further partially deployed configuration. More specifically, the strap 32 has been released and the support member 34 has been actuated by a suitable actuation mechanism (not shown) that allows the truss structure 30 to be expanded by, for example, spring loaded tension provided by support rods 40 within the truss structure 30. One suitable truss structure of this type can be found in U.S. Pat. No. 5,680,145 issued Oct. 21, 1997 to Thomson et al., although many other types will be applicable. In this non-limiting embodiment, the reflector 24 is fully deployed into an elliptical operational shape prior to the boom 22 being extended. However, it is noted that in other embodiments, the reflector 24 can be opened or deployed after the boom 22 has been extended.

In this non-limiting embodiment, after the reflector 24 is fully deployed, the boom 22 is extended to put the reflector 24 in its operating position the proper distance from the spacecraft body. FIG. 4 is an isometric view of a spacecraft 42 including a spacecraft body 44 in which the spacecraft structure 10 is positioned, and showing the assembly 20 in its fully deployed configuration, where the reflector 24 includes a membrane 46 supported by the truss structure 30. In one non-limiting embodiment for extending the boom 22, a tip of the boom 22 is released by a pyro-actuated and a spring loaded stem mechanism 48 that pushes a smallest diameter tubular section 50 of the boom 22 out of and away from the base section 26 so that boom sections 52 are extended therefrom in a telescoping manner. In one non-limiting embodiment, the deployment of the boom 22 using the stem mechanism 48 is of the type shown in U.S. Pat. No. 5,315,795 issued May 31, 1994 to Chae et al., where the sections 52 are coupled together by spring loaded and retractable pins (not shown). FIG. 4 shows the boom 22 completely extended where the boom sections 52 get progressively smaller from the spacecraft 42 to the reflector 24 to allow the nesting configuration of the boom 22.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A boom and reflector assembly for a spacecraft, said assembly comprising:
a telescopic boom including a plurality of tubular sections including a base section where the sections are nested together within the base section when the boom is in a stowed position; and
a reflector including an outer truss structure having truss rods that are foldable to allow the reflector to be collapsed into a stowed configuration, said reflector being mounted to only an end face of an outer one of the tubular sections having a smallest diameter by a support member, wherein the assembly is configured to be deployed from the spacecraft by releasing the boom in a telescoping manner.

2. The assembly according to claim 1 wherein the base section is mounted to a stowing cradle within the spacecraft by a root hinge, and wherein deploying the assembly includes opening the root hinge to rotate the assembly away from the stowing cradle.

3. The assembly according to claim 2 wherein the reflector is mounted to the outer tubular section by a wrist hinge, and wherein deploying the assembly includes rotating the collapsed reflector on the wrist hinge.

4. The assembly according to claim 3 wherein deploying the assembly includes extending the tubular sections of the boom in the telescoping manner to move the reflector away from the spacecraft prior to the reflector being opened to a deployed configuration.

5. The assembly according to claim 3 wherein the assembly is structurally configured to open the reflector to a deployed configuration before the boom is extended in the telescoping manner.

6. The assembly according to claim 1 wherein the reflector has an elliptical shape in its deployed configuration.

7. The assembly according to claim 1 wherein the tubular sections of the boom are extended in the telescoping manner by a stem mechanism that is coupled to the stowing cradle and an outer one of the tubular sections.

8. The assembly according to claim 1 wherein the boom includes ten tubular sections each being ten feet long.

9. The assembly according to claim 1 wherein the boom is a graphite boom.

10. The assembly according to claim 1 wherein the reflector is part of a communications or radar system.

11. A boom and reflector assembly for a communications or radar satellite, said assembly comprising:
a telescopic boom including a plurality of tubular sections including a base section where the sections are nested together within the base section when the boom is in a stowed position, said base section being mounted to a stowing cradle within the spacecraft by a root hinge; and
a reflector including an outer truss structure having truss rods that are foldable to allow the reflector to be collapsed into a stowed configuration, said reflector being mounted to only an end face of an outer one of the tubular sections having a smallest diameter by a support member and a wrist hinge, wherein the assembly is structurally, configured to be deployed from the spacecraft by releasing the root hinge to rotate the boom and the reflector assembly away from the stowing cradle, rotating the collapsed reflector on the wrist hinge, deploying the reflector from the collapsed configuration to a deployed configuration having an elliptical shape, and then extending the tubular sections of the boom in a telescoping manner using a stem mechanism to move the deployed reflector away from the spacecraft.

12. The assembly according to claim 11 wherein the boom includes ten tubular sections each being ten feet long.

13. The assembly according to claim 11 wherein the boom is a graphite boom.

14. A method for deploying a boom and reflector assembly from a spacecraft, said assembly including a telescopic boom having a plurality of tubular sections including a base section where the sections are nested together within the base section when the boom is in a stowed position, said base section being mounted to a stowing cradle within the spacecraft by a root hinge, and a reflector including an outer truss structure having truss sections that are foldable to allow the reflector to be collapsed into a collapsed configuration when in the stowed position, said reflector being mounted to only an end face of an outer one of the tubular sections having a smallest diameter by a support member and a wrist hinge, said method comprising:
releasing the root hinge to rotate the boom and the reflector away from the stowing cradle;
rotating the collapsed reflector on the wrist hinge; and
extending the tubular sections of the boom in a telescoping manner to move the reflector away from the spacecraft.

15. The method according to claim 14 further comprising deploying the reflector from the collapsed configuration to a deployed configuration before the boom is extended.

16. The method according to claim 15 wherein the reflector has an elliptical shape in its deployed configuration.

17. The method according to claim 14 wherein extending the tubular sections of the boom in a telescoping manner includes using a stem mechanism that is coupled to the stowing cradle and the outer one of the tubular sections.

18. The method according to claim 14 wherein the assembly is mounted to the stowing cradle within the spacecraft between spacecraft side walls.

19. The method according to claim 14 wherein the boom includes ten tubular sections each being ten feet long.

20. The method according to claim 14 wherein the boom is a graphite boom.
